(19) United States
(12) Patent Application Publication
(10) Pub. No.: US 2016/0125167 A1
(43) Pub. Date: May 5, 2016

(54) METHOD AND DEVICE

(71) Applicant: NIKON CORPORATION, Chiyoda-ku, Tokyo (JP)

(72) Inventors: Satoshi HASEGAWA, Yokohama-shi (JP); Noriyasu KOTANI, Tokyo (JP); Hisashi TAI, Kawasaki-shi (JP); Terutada AKIYAMA, Okegawa-shi (JP); Taichi GOTO, Tokyo (JP); Hiroshi KAMEHARA, Yokohama-shi (JP); Yu MURAKOSHI, Niiza-shi (JP); Masakazu SEKIGUCHI, Kawasaki-shi (JP)

(21) Appl. No.: 14/775,332

(22) PCT Filed: Feb. 13, 2014
(86) PCT No.: PCT/JP2014/053366

§ 371 Date: Dec. 2, 2015

(30) Foreign Application Priority Data
Mar. 11, 2013 (JP) 2013-047854

(51) Int. Cl. G06F 19/00

(52) U.S. Cl. CPC G06F 19/3475; G06F 19/3456

(57) ABSTRACT

A method implemented by a computer includes: obtaining information on a first medicine before being taken or information on a food or beverage before being consumed; communicating with an external device that stores information on a second medicine being taken; transmitting the information on the first medicine or the information on the food or beverage to the external device; and notifying a user that the first medicine or the food or beverage is a medicine or a food or beverage that is prohibited or restricted from being consumed together with the second medicine when receiving information that the first medicine or the food or beverage is a medicine or a food or beverage that is prohibited or restricted from being consumed together with the second medicine.

### TECHNICAL FIELD

The present invention relates to an electronic device and a program.

### BACKGROUND ART

Medicine notebooks issued in a pharmacy have been conventionally handled on a paper basis. However, there has been recently suggested technologies relating to digitization of the medicine notebooks (see Patent Document 1).

### PRIOR ART DOCUMENTS

### Patent Documents

Patent Document 1: Japanese Patent Application Publication No. 2012-113523

### SUMMARY OF THE INVENTION

### Problems to be Solved by the Invention

However, the conventional suggestion remains confined to the digitization of the medicine notebooks, and fails to consider the diets of patients.

The present invention has been made in the view of the above problem, and aims to provide an electronic device and a program capable of managing the intake of food and beverage.

### Means for Solving the Problems

The electronic device of the present invention includes: a storing unit that stores data on food or beverage of which an intake is prohibited or food or beverage of which an intake is restricted; and a notification unit that performs notification when food or beverage stored in the storing unit has been consumed or is likely to be consumed.

In this case, the storing unit may store data on food or beverage of which an intake is prohibited or food or beverage of which an intake is restricted in association with a medicine. In this case, an acquisition unit that acquires a medicine to be taken may be provided, and the storing unit may store data on food or beverage of which an intake is prohibited or food or beverage of which intake is restricted when a medicine is taken.

The electronic device of the present invention may include a setting unit that sets a period during which the intake of the food or beverage is prohibited or a period during which the intake of the food or beverage is restricted. Moreover, when the storing unit stores data on food or beverage of which an intake is prohibited or food or beverage of which an intake is restricted, a setting unit that sets a period during which the intake of the food or beverage is prohibited or a period during which the intake of the food or beverage is restricted in accordance with a prescription period of the medicine may be provided.

Additionally, the electronic device of the present invention may include a receive unit that receives information indicating that food or beverage stored in the storing unit has been consumed or information indicating that the food or beverage is likely to be consumed. In this case, the receive unit may receive the information through proximity communication or intra-body communication. Additionally, a transmit unit that transmits the information received by the receive unit to an external device may be provided. Moreover, the storing unit may store the information received by the receive unit. Moreover, the electronic device of the present invention may include an image capture unit that captures an image; and a detection unit that detects, based on an image captured by the image capture unit, that food or beverage stored in the storing unit has been consumed, or that the food or beverage is likely to be consumed. In this case, the electronic device may include an input unit that inputs an identification result of a food item, and the detection unit may detect that food or beverage stored in the storing unit has been consumed, or that the food or beverage is likely to be consumed based on an image captured by the image capture unit and an input of the input unit.

Additionally, in the electronic device of the present invention, the notification unit may change a timing of the notification depending on an intake amount of food or beverage stored in the storing unit. Additionally, the notification unit may perform notification regarding diet. Moreover, the notification unit may include a display unit that displays the food or beverage of which the intake is prohibited or the food or beverage of which the intake is restricted.

The program of the present invention is a program causing a computer to execute a process, the process including: storing data on food or beverage of which an intake is prohibited or food or beverage of which an intake is restricted in a storing unit; and performing notification when food or beverage stored in the storing unit has been consumed or the food or beverage is likely to be consumed.

### Effects of the Invention

The electronic device and the program of the present invention have effects that enable to manage the intake of food and beverage.

### BRIEF DESCRIPTION OF DRAWINGS

FIG. 1 is a block diagram illustrating a configuration of an information processing system in accordance with a first embodiment;

FIG. 2 illustrates a user having a meal;

FIG. 3 illustrates an intake combination table;

FIG. 4 illustrates a resistance value table;

FIG. 5A illustrates a prescribed medicine table, and FIG. 5B illustrates a diet log;

FIG. 6 is a flowchart illustrating a process executed by a control unit 111 of a mobile terminal 100;

FIG. 7 illustrates data transmitted at step S30 of FIG. 6;

FIG. 8 is a block diagram illustrating a configuration of an information processing system in accordance with a second embodiment;

FIG. 9 is a perspective view of a spectacle-type device; and

FIG. 10 illustrates an appearance feature parameter table of the second embodiment.

### MODES FOR CARRYING OUT THE INVENTION

### First Embodiment

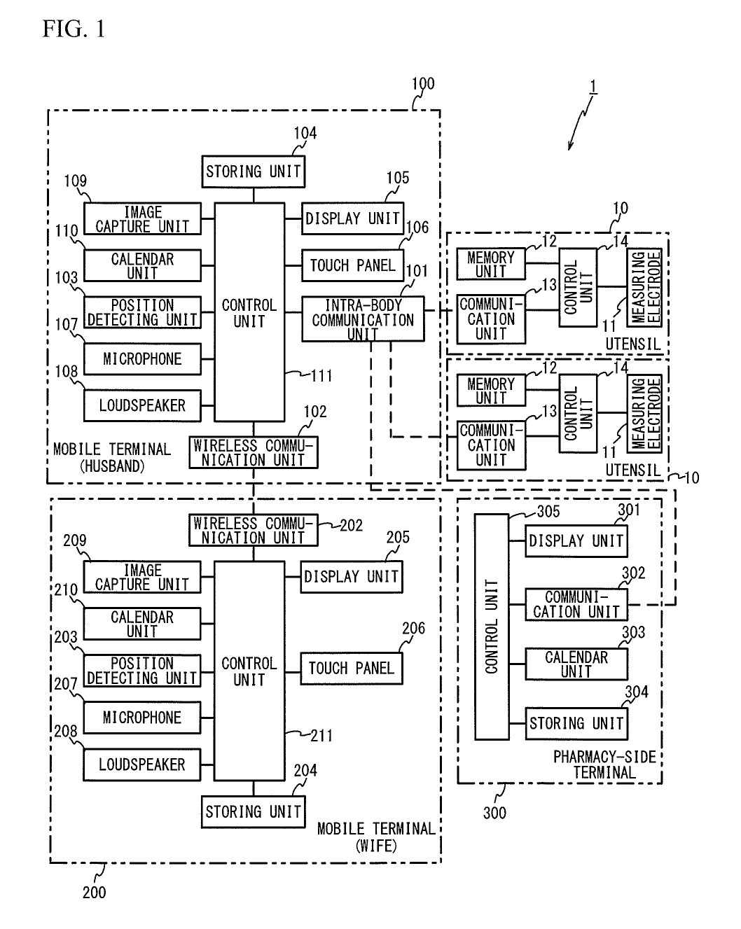

Hereinafter, a detailed description will be given of an information processing system in accordance with a first embodiment based on FIG. 1 through FIG. 7. FIG. 1 is a block diagram illustrating a configuration of an information processing system 1 in accordance with the first embodiment.

The information processing system 1 is a system used to alert a user so that the user does not eat or drink food or beverage that results in adverse effect when consumed together with the medicine being taken by the user.

The information processing system 1 includes, as illustrated in FIG. 1, one or more utensils 10, mobile terminals 100, 200, and a pharmacy-side terminal 300.

(Utensil 10)

The utensil 10 is an eating utensil such as chopsticks, a spoon, or a fork, and has a function that detects a food item or a dish (hereinafter, simply referred to as a food item) that the user is eating or is going to eat, and transmits it to the mobile terminal 100. The utensil 10 includes, as illustrated in FIG. 1, a measuring electrode 11, a memory unit 12, a communication unit 13, and a control unit 14. The utensil 10 is also disclosed in Japanese Patent Application No. 2012-278339 previously filed by the applicant of this application.

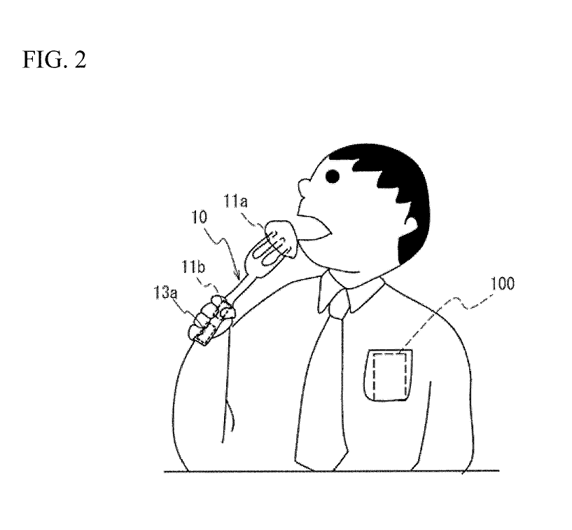

The measuring electrode 11 is an electrode that detects a resistance value corresponding to a food item, and includes, as illustrated in FIG. 2, an electrode 11a located in a part (e.g., the tip of a fork) that comes in contact with a food item, and an electrode 11b located in a part (e.g., the handle of a fork) that comes in contact with a body of the user. The measuring electrode 11 detects a resistance value between a food item and a human body via a mouth, and outputs it to the control unit 14.

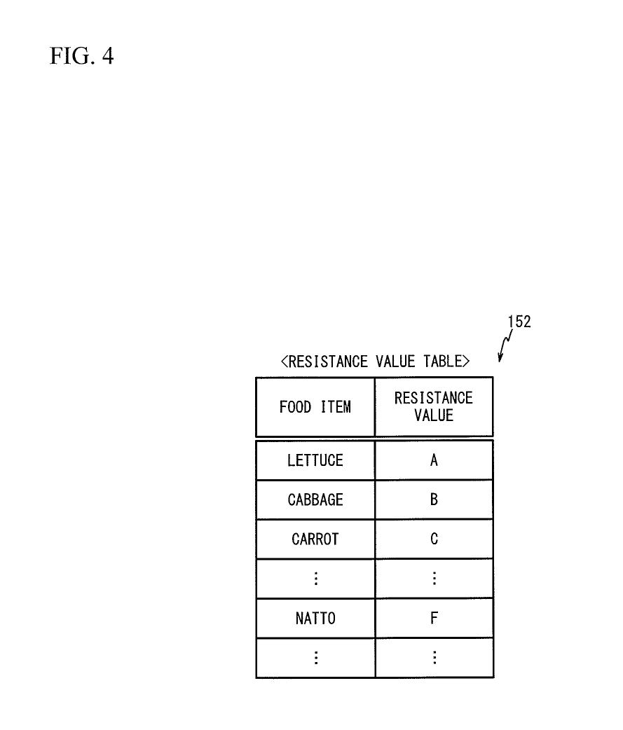

The memory unit 12 includes a non-volatile semiconductor memory (e.g., a flash memory), and stores the resistance value measured by the measuring electrode 11. The memory unit 12 may store a table that defines the resistance value of each food item (a table illustrated in FIG. 4). Liquid food items such as soups are categorized into food, and thus the resistance values of liquid food items are also stored in the table.

The communication unit 13 communicates with other devices (e.g., the mobile terminal 100) through proximity communication such as Bluetooth (registered trademark), RFID (Radio Frequency Identification), or TransferJet (registered trademark), or intra-body communication that is conducted via a human body. In the first embodiment, the communication unit 13 is an intra-body communication unit including an electrode unit 13a (see FIG. 2) that is located in the handle of the utensil 10 and comes in contact with the hand of the user. The intra-body communication unit includes a transmit unit composed of an electric circuit having a bandpass filter, and modulates data to be transmitted to generate transmit signals. The intra-body communication unit may have a receive function. In the first embodiment, the food item that makes contact with the utensil 10 and that the user put into the mouth (consumed or was going to consume) is transmitted to the mobile terminal 100. The utensil 10 may be referred to as an instrument capable of coming in contact with the upper body of the user such as the hand or the mouth of the user.

The control unit 14 includes a CPU, overall controls the utensil 10, and controls the transmission of the resistance value of a food item measured by the measuring electrode 11 to the mobile terminal 100 via the communication unit 13. When the memory unit 12 stores a table defining the resistance value of each food item, the control unit 14 transmits the name of the food item that the user put into the mouth, which is identified from the measured value and the resistance value in the table, to the mobile terminal 100 through the communication unit 13.

(Mobile Terminal 100)

The mobile terminal 100 is an information device that is used while being carried by the user. The mobile terminal 100 may be a mobile phone, a smartphone, a tablet-type computer, a PHS (Personal Handy-phone System), or a PDA (Personal Digital Assistant). In the first embodiment, the mobile terminal 100 is a smartphone. Assume that a user (e.g., a husband) who is taking a medicine in a family has the mobile terminal 100, as an example.

The mobile terminal 100 includes, as illustrated in FIG. 1, an intra-body communication unit 101, a wireless communication unit 102, a position detecting unit 103, a storing unit 104, a display unit 105, a touch panel 106, a microphone 107, a loudspeaker 108, an image capture unit 109, a calendar unit 110, and a control unit 111.

The intra-body communication unit 101 includes an electrode, and transmits/receives data to/from, for example, the utensil 10 (the communication unit 13) through a human body. For intra-body communication, used are an electric current method that transmits information by passing a minute electric current through a human body and modulating the electric current, an electric field method that transmits information by modulating an electric field induced on the surface of a human body, or the like. In the electric field method, the intra-body communication can be conducted even when the user does not make direct contact with the electrode. Thus, the first embodiment employs the electric field method so that the intra-body communication is established even when the user puts the mobile terminal 100 in a pocket (e.g., a breast pocket). When a user having the mobile terminal 100 is female, the mobile terminal 100 may be put in a bag (a sporran) instead of a pocket. In such a case, a proximity communication unit may be provided instead of the intra-body communication unit 101, and data may be transmitted/received to/from the communication unit 13 of the utensil 10 through proximity communication.

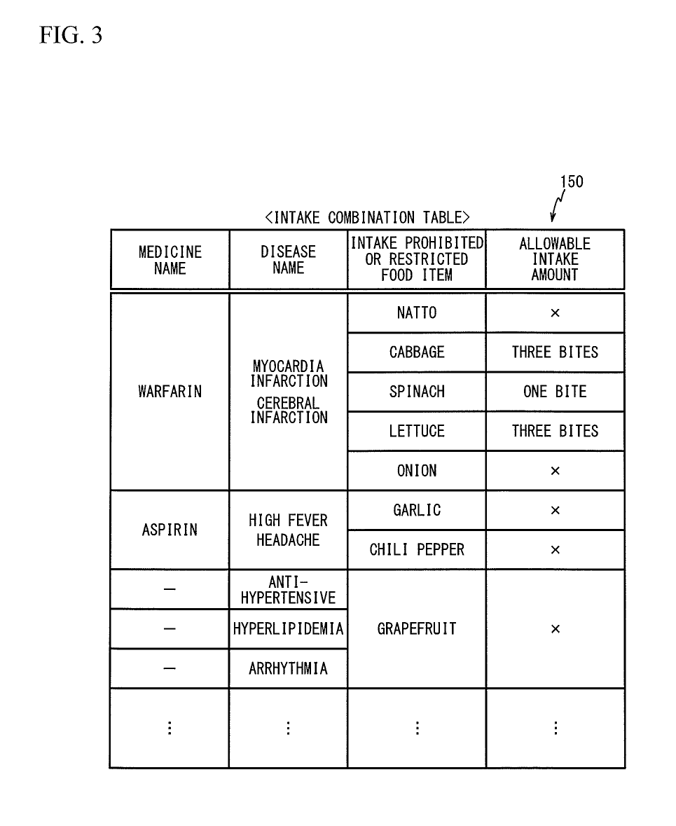

The wireless communication unit 102 enables communication with other mobile terminals and connection to a network, and may employ various wireless communication methods. In the first embodiment, the wireless communication unit 102 transmits information on food items that the user consumed to the mobile terminal 200, and acquires information on an intake combination of medicines and food items (information of an intake combination table 150 (FIG. 3) described later) from the Internet or the like.

The position detecting unit 103 is, for example, a GPS (Global Positioning System) module. The position detecting unit 103 detects a position (e.g., latitude and longitude) of the mobile terminal 100.

The storing unit 104 is a non-volatile semiconductor memory, and stores programs for controlling the mobile terminal 100 executed by the control unit 111, various parameters used to control the mobile terminal 100, data on the diet of the user and the medicine being taken, and information on the intake combination of medicines and food items.

The storing unit 104 stores, for example, the intake combination table 150 illustrated in FIG. 3. The intake combination table 150 includes, as illustrated in FIG. 3, fields of medicine name, disease name, intake prohibited or restricted food item, allowable intake amount. The field of medicine name stores the name of a medicine such as warfarin, or aspirin. The field of disease name stores the name of disease for which the medicine is prescribed. The field of intake prohibited or restricted food item stores the name of a food item of which the intake is prohibited or restricted when the user is taking a certain medicine or suffers from a disease corresponding to a certain medicine. The field of allowable intake amount stores “x” when the food item is an intake prohibited food, or one bite, three bites, or five grams when the food item is the intake restricted food.

For example, when the user is taking warfarin, which is an anticoagulant prescribed for a disease such as myocardial infarction or cerebral infarction, the user should be prohibited or restricted from taking food items such as natto, cabbage, spinach, and lettuce that contain lots of vitamin K. Therefore, these food items are stored in the intake combination table 150 illustrated in FIG. 3. The reason why the intake of food items containing lots of vitamin K is prohibited or restricted is because warfarin is a medicine prescribed to decrease the activity of vitamin K (hemostatic action). In addition, onion overly enhances the effect of warfarin, and thus is stored as the intake prohibited food item.

In the same manner, the intake combination table 150 stores garlic and chili pepper as the intake prohibited food item for an analgesic antipyretic. In addition, the intake combination table 150 stores grapefruit as the intake prohibited food item for medicines for antihypertensive, hyperlipidemia, and arrhythmia.

The detailed information on the intake combination of medicines and food items are described in http://www.jsmi.jp/book/base_05.html. For convenience sake, the field of allowable intake amount in the intake combination table 150 of FIG. 2 stores values different from the actual allowable intake amount.

The storing unit 104 also stores a resistance value table 152 illustrated in FIG. 4. The resistance value table 152 includes fields of food item and resistance value. The resistance value is a resistance value including resistance values of a food item and the body of the user, and thus the values in the resistance value table 152 differ depending on the user. The control unit 111 may make the user put the utensil 10 in user's mouth to acquire the resistance value of the body of the user at the initialization phase, and calibrate the value of the resistance value table 152 based on the resistance value of the body.

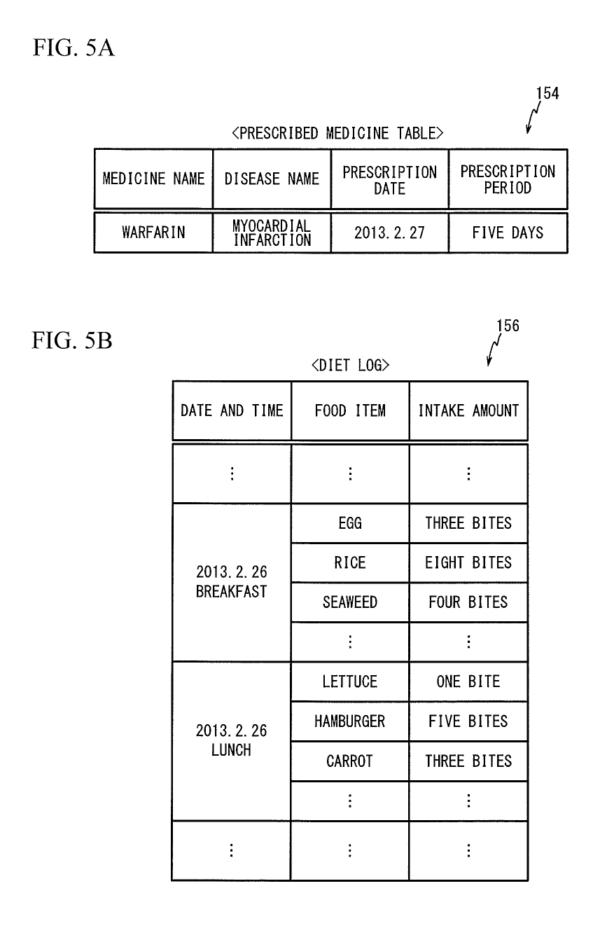

The storing unit 104 further stores a prescribed medicine table 154 illustrated in FIG. 5A. The prescribed medicine table 154 includes fields of medicine name, disease name, prescription date, and prescription period. The data stored in the prescribed medicine table 154 is data acquired from the pharmacy-side terminal 300 described later.

The storing unit 104 also stores a diet log 156 (see FIG. 5B) that stores the history of daily meals of the user obtained with the measuring electrode 11. The diet log 156 has fields of date and time, food item, and intake amount. The field of date and time stores date and the classification of a meal (such as breakfast, lunch, and dinner). The field of food item stores the food item that the user put into the mouth. The field of intake amount stores the amount of the food item that the user consumed (the number of bites in FIG. 5B). The diet log 156 reveals the food items that the user often consumes, and the food items that the user consumes very little.

Back to FIG. 1, the display unit 105 is located on a predetermined surface (hereinafter, referred to as a principal surface) of the main body of the mobile terminal 100, and displays images, various information, and an operation input image such as buttons. The display unit 105 is a device using, for example, a liquid crystal display element.

The touch panel 106 inputs information in response to the touch of the user. The touch panel 106 is located on the display unit 105 or is embedded in the display unit 105. Thus, the touch panel 106 inputs various information when the user touches the surface of the display unit 105. The microphone 107 is located at the principal surface side of the main body of the mobile terminal 100 and below the display unit 105, and is located near the mouth when the user uses a telephone function. The loudspeaker 108 is located at the principal surface side of the main body of the mobile terminal 100 and above the display unit 105, and is located near the ear when the user uses the telephone function.

The image capture unit 109 is located above the display unit 105 and near the loudspeaker 108, and captures an image of the situation of the user while the user is holding (using) the mobile terminal 100. The image capture unit 109 is composed of an imaging lens and imaging elements (a CCD and a CMOS device) adopting the RGB Bayer arrangement. The image capture unit 109 may be located on the surface (rear surface) opposite to the principal surface.

The calendar unit 110 acquires time information such as year, month, day, and time, and outputs it to the control unit 111. The calendar unit 110 may have a clocking function to measure the time taken for the user to finish a meal.

The control unit 111 includes a CPU, and overall controls the mobile terminal 100. In the first embodiment, the control unit 111 executes a process for logging the diet of the user, and executes a process for notifying or alerting the user when the intake combination of the medicine being taken by the user and the food item is bad.

(Mobile Terminal 200)

The mobile terminal 200 is a mobile terminal that the wife of the user carries in the first embodiment. The mobile terminal 200 receives, from the mobile terminal 100, the dietary history of the husband and information on food items of which the intake by the husband is prohibited or restricted. In the first embodiment, the intra-body communication unit is omitted in the mobile terminal 200, but the intra-body communication unit may be provided as with in the mobile terminal 100. The other configurations of the mobile terminal 200 may be the same as those of the mobile terminal 100. The components of the mobile terminal 200 differ from those of the mobile terminal 100 only in reference numerals (100 is added to the reference numerals of the corresponding components of the mobile terminal 100), and thus the detailed description is omitted.

(Pharmacy-Side Terminal 300)

The pharmacy-side terminal 300 is a terminal used by a pharmacist in a pharmacy, and transmits information on the medicine to be taken by the user to the mobile terminal 100. The pharmacy-side terminal 300 includes a communication unit 302, a display unit 301, a calendar unit 303, a storing unit 304, and a control unit 305.

The communication unit 302 includes an electrode unit for communicating with the intra-body communication unit 101 of the mobile terminal 100. The communication method of the communication unit 302 is not limited to intra-body communication, and may be communication. For example, when the user touches the electrode unit while the mobile terminal 100 is put in a breast pocket or the like, information is transmitted and received between the control unit 111 of the mobile terminal 100 and the control unit 305 of the pharmacy-side terminal 300 through the communication unit 302 and the intra-body communication unit 101.

The display unit 301 uses a liquid crystal display element to display information on the medicine to be handed to the user. The user can view information on the medicine prescribed by a doctor or information on the medicine to be purchased by watching the display unit 301.

The display unit 301 displays icons of “Yes” and “No” together with a message such as “Transmit the data of the medicine to the mobile terminal?” to the user, and makes the user touch the icon. As the first embodiment employs intra-body communication, the data of the medicine to be taken by the user (the medicine name, the disease name, the prescription period, and the like) can be transmitted to the mobile terminal 100 by configuring such that intra-body communication is established when the user touches the icon of “Yes”, for example. When the communication unit 302 conducts proximity communication, proximity communication may be established when the user holds the mobile terminal 100 over the icon of “Yes”. The mobile terminal 100 stores the data of the medicine to be taken by the user received from the pharmacy-side terminal 300 in the prescribed medicine table 154 of FIG. 5A.

The calendar unit 303 acquires date and time information such as year, month, date, and time, and outputs the date and time information so that the date and the time are transmitted together with the data of the medicine when the communication unit 302 transmits the data of the medicine to the mobile terminal 100 of the user. The mobile terminal 100 stores the date and time information received from the pharmacy-side terminal 300 in the field of prescription date in the prescribed medicine table 154 of FIG. 5A.

The storing unit 304 includes a non-volatile memory, and stores data on the use of medicines of users. The storing unit 304 may store precautions against the use of the medicine, in addition to the above information. In this case, the communication unit 302 may transmit, to the mobile terminal 100, information on the intake combination with medicines among the precautions against the use of the medicine together with the data of the medicine and the date and time information. The mobile terminal 100 stores the information on the intake combination with the medicine in the intake combination table 150 (FIG. 3).

The control unit 305 includes a CPU, and overall controls the pharmacy-side terminal 300. In the first embodiment, the control unit 305 controls the transmission of various kinds of data on the medicine to the mobile terminal 100 of the user.

(Process of the Control Unit 111)

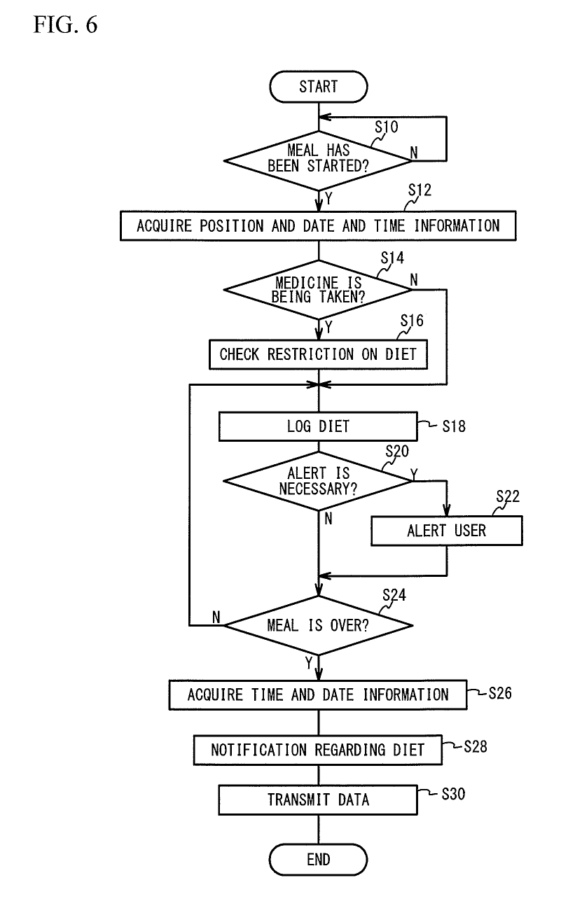

A detailed description will be given of a process by the control unit 111 of the mobile terminal 100 of the first embodiment along a flowchart of FIG. 6. In the first embodiment, assume that the husband has purchased warfarin for five days in a pharmacy in accordance with the prescription by a doctor. In addition, assume that the storing unit 104 (the prescribed medicine table 154 (FIG. 5A)) of the mobile terminal 100 stores information received through intra-body communication with the pharmacy-side terminal 300. The control unit 111 may refer to the intake combination table 150 of FIG. 3 and the diet log 156 of FIG. 5B and execute the process of the flowchart of FIG. 6 when the user has the potential to or tends to consume a food item of which the intake is prohibited or restricted (and does not execute the process when the user has no potential to consume a food item of which the intake is prohibited or restricted), or may execute the process of the flowchart of FIG. 6 when the husband is taking a medicine.

In the process of FIG. 6, at step S10, the control unit 111 waits till it detects that the user has started a meal. In this case, the control unit 111 can determine that the meal has been started when detecting the establishment of intra-body communication between the mobile terminal 100 and the utensil 10 because the user holds the utensil 10 while holding the mobile terminal 100 (putting the mobile terminal 100, for example, in a breast pocket). The control unit 111 may determine whether the user has started the meal by incorporating the detection result (the positional data of the user) by the position detecting unit 103 and the date and time information output from the calendar unit 110. The control unit 111 may determine that the user has started the meal when detecting the input of a particular word expressing gratitude before meals such as “itadakimasu” to the microphone 107.

When the user starts the meal, the control unit 111 moves to step S12, and acquires the date and time information output from the calendar unit 110 and the detection results (the positional data of the user) by the position detecting unit 103. The reason why the date and time information is acquired is for taking the data of each day of the user (the diet log 156) and for categorizing the meal of the user into breakfast, lunch, dinner, brunch, or midnight snacks. The reason why the positional data is acquired is for identifying the place that the user is having the meal. Here, as an example, assume that it is detected from the positional data of the position detecting unit 103 that the user is at the office (a company cafeteria), and the meal of the user is categorized into lunch because the output of the calendar unit 110 is 12:15 p.m.

At subsequent step S14, the control unit 111 determines whether the user is taking a medicine. That is to say, the control unit 111 refers to the prescribed medicine table 154 of FIG. 5A, and determines whether there is a medicine that the user is currently taking. Here, the control unit 111 determines whether there is a medicine that the user is currently taking by determining that the current date is within the prescription period of the medicine. The control unit 111 may determine whether the user is taking a medicine by determining whether the current date is within a period calculated by adding a predetermined number of days (a day or two days) to the prescription period of the medicine. This is because a person who takes a medicine may take the medicine after the prescription period when the person forgot taking the medicine.

When determining that the user is taking a medicine (when the determination of step S14 is Yes), the control unit 111 proceeds to step S16, and checks the restriction on the diet of the user. That is to say, the control unit 111 checks whether the information corresponding to the medicine within the prescription period or to the disease name in the prescribed medicine table 154 is stored in the intake combination table 150. Then, the process proceeds to step S18. In the first embodiment, the user is taking warfarin, and thus the intake of natto and onion is prohibited, and the intake of cabbage (the allowable intake amount is three bites), spinach (the allowable intake amount is one bite), and lettuce (the allowable intake amount is three bites) is restricted.

When the determination at step S14 is No, the process skips step S16 and proceeds to step S18.

At step S18, the control unit 111 logs the diet of the user. The control unit 111 acquires the resistance value of the food item measured by the measuring electrode 11, i.e., the resistance value of the food item that the user put into the mouth, through intra-body communication with the utensil 10, detects what the user ate (put into the mouth) based on the resistance value table 152, and then stores it in the storing unit 104 (the diet log 156). When the resistance values table is stored in the memory unit 12 of the utensil 10, the name of the food item that the user consumed is transmitted from the utensil 10. Thus, the control unit 111 stores the received name of the food item in the storing unit 104 (the diet log 156).

At subsequent step S20, the control unit 111 determines whether it is necessary to alert the user with respect to the food item that the user put into the mouth.

For example, when the user puts lettuce in a salad into the mouth at lunch. In this case, as the lettuce is the intake restricted food item, the determination at step S20 becomes Yes when the intake amount of lettuce has already exceeded three bites over one day, and the control unit 111 proceeds to step S22. At step S22, the control unit 111 alerts the user. To alert the user, a voice such as “The intake of lettuce should be avoided.” may be output from the loudspeaker 108 of the mobile terminal 100. Alternatively, the mobile terminal 100 may be vibrated by a vibrator not illustrated, or a message such as “The intake of lettuce should be avoided.” may be displayed on the display unit 105 while the mobile terminal 100 is vibrated.

When the process at step S22 is ended, or the determination at step S20 is No, the control unit 111 moves to step S24. At step S24, the control unit 111 determines whether the user has finished the meal. In this case, the control unit 111 determines that the user has finished the meal when a predetermined time period (e.g., five minutes) passes after the intra-body communication with the utensil 10 is lost, when the user moves, or when the input of a specific word used after meals such as “gochisosama deshita” to the microphone 107 is detected with a voice-recognition technology. When the determination at step S24 is No, the user is yet eating the meal. Thus, the processes and determinations of steps S18 through S24 are repeated (the acquisition of the diet log and the alert are executed). To detect the intake of liquid from a cup or a glass, the method disclosed in Japanese Patent Application No. 2012-135901 previously filed by the applicant of the present application may be employed.

When it is determined that the user is not taking a medicine at aforementioned step S14, the determination at step S20 and the process at step S22 may be omitted.

When the user has finished the meal, and the determination at step S24 becomes Yes, the process moves to step S26, and the control unit 111 acquires the current date and time information from the output of the calendar unit 110. The control unit 111 can calculate the time it took for the user to finish the meal from the date and time information acquired at step S26 and the date and time information acquired at step S12. This calculation allows the control unit 111 to determine whether the user ate the meal quick. The control unit 111 can detect the frequency at which the user conveys food items to user's mouth from the change in the resistance value of the measuring electrode 11.

At subsequent step S28, the control unit 111 performs notification regarding the diet. In this case, the control unit 111 can display a message on the display unit 105 after vibrating the mobile terminal 100 by a vibrator not illustrated. The control unit 111 can display a message such as “The intake of lettuce should be avoided during the prescription period of the currently taking medicine (warfarin).” or “You tends to eat quick.”. Additionally, the control unit 111 may notify the user of whether the medicine was taken within 30 minutes after the meal was over at step S24. This can prevent the user from forgetting to take a medicine after meal.

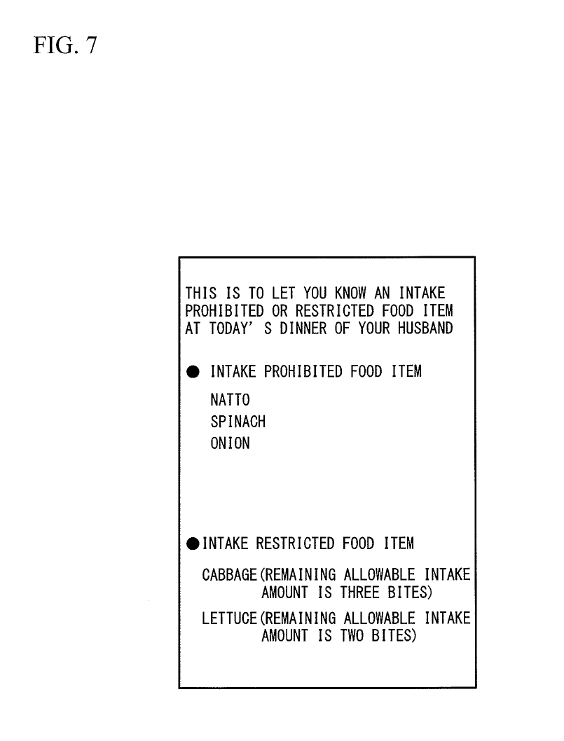

At subsequent step S30, the control unit 111 transmits data on the diet of the user (the husband) to the mobile terminal 200 held by the wife through the wireless communication unit 102. The control unit 111 transmits, for example, information on the intake prohibited or restricted food item of the husband illustrated in FIG. 7 to the mobile terminal 200 based on the log of the diet of the husband. This allows the wife to know the food item that the husband has to avoid eating at dinner, and thereby allows the wife to avoid purchasing the food items of which the intake is prohibited, or not to cook the meal using the food item of which the intake is prohibited.

A control unit 211 of the mobile terminal 200 may display the information of FIG. 7 on a display unit 205 when receiving the information of FIG. 7 from the mobile terminal 100 of the husband, but this does not intend to suggest any limitation. For example, the control unit 211 may display the information of FIG. 7 on the display unit 205 when it is detected that the wife is in a store handling food such as a supermarket from the output of the position detecting unit 203. This allows the wife to know the intake prohibited or restricted food item of the husband at a proper timing such as the time of purchasing ingredients for dinner.

The control unit 111 can determine whether the ingredient is a food item that the user (husband) often consumes at breakfast or dinner from the diet log. Thus, the control unit 111 can transmit information that takes the determination results into consideration to the mobile terminal 200. For example, when the user (husband) does not eat natto at all in a regular meal, the letters of natto may be displayed smaller in size than the letters of other food items (such as lettuce) in the information of FIG. 7.

The process of FIG. 7 is repeatedly executed while the power of the mobile terminal 100 is ON.

As described above in detail, the mobile terminal 100 of the first embodiment stores data on an intake prohibited or restricted food item in the storing unit 104, and the control unit 111 notifies the user through the loudspeaker 108 or the display unit 105 when it acquires information indicating that a food item stored in the storing unit 104 is put into the mouth (consumed or is likely to be consumed) by the user from the utensil 10. This allows the user to avoid consuming the food item without checking the intake prohibited or restricted food item in advance before meals. That is to say, the mobile terminal 100 of the first embodiment allows the user to manage the intake of food items.

In the first embodiment, the storing unit 104 stores information on the intake prohibited or restricted food item in association with a medicine. This configuration enables to prevent the user who is taking a medicine from consuming a food item of which the intake combination with the medicine is bad, and thereby, enables to prevent the health of the user from declining by the intake of the food item of which the intake combination with the medicine is bad.

In addition, in the first embodiment, the control unit 111 acquires information on a medicine to be taken by the user (the information of the prescribed medicine table 154) from the pharmacy-side terminal 300 through intra-body communication. Additionally, the storing unit 104 stores information on food items of which the intake is prohibited or restricted when the medicine is taken (the intake combination table 150). This allows the control unit 111 to properly manage the intake of food items by the user even when the information transmitted from the pharmacy-side terminal 300 does not contain the information on the intake prohibited or restricted food item.

Additionally, in the first embodiment, the control unit 111 sets a period during which the intake of the food item is restricted in accordance with the prescription period of the medicine in the prescribed medicine table 154 (S14), and thus can restrict the intake of the food item during only the period that it is highly probable that the user is taking the medicine.

Additionally, in the first embodiment, the control unit 111 receives the state of the intake of the food items from the utensil 10. Thus, the usability is improved compared to a case where the user inputs the food item consumed by the user manually.

Additionally, in the first embodiment, the control unit 111 transmits the information on the diet of the husband to the mobile terminal 200 of the wife, and thus enables to share the information on the diet of the husband among the family members. This enables to manage the intake of the food items more effectively.

In the first embodiment, the storing unit 104 (the diet log 156) stores the log of the diet received from the utensil 10. Thus, the user may be notified of not only the intake prohibited or restricted food item but also information on the diet such as the time that the user spent on the meal and the number of consumed items.

Additionally, in the first embodiment, the intake restricted food item (the food item of which the allowable intake amount is predetermined) is consumed, the alert and notification is conducted at different timings depending on the amount consumed by the user. This allows the alert not to be conducted at a timing when the urgency is not required during the meal, thereby improving the usability.

The above-described first embodiment does not alert the user when the intake amount does not exceed the allowable intake amount per day at step S20, but does not intend to suggest any limitation. The user may be alerted (S22) every time when the intake restricted food item is put into the mouth. In this case, the user may be notified of the remaining allowable intake amount.

In the above-described first embodiment, the control unit 111 sets a period during which the intake of the intake prohibited or restricted food item is restricted in accordance with the prescription period of a medicine (S14), but this does not intend to suggest any limitation. For example, the control unit 111 may set the period during which the intake is restricted in accordance with the input from the user.

The above-described first embodiment describes dietary restriction during the period that a medicine is being taken. However, even when the medicine is not being taken, there may be a food item (including allergy-provoking food) of which the intake had better to be avoided when the user is undergoing treatment or when the date of examination is already decided. In such a case, the notification (alert) on dietary restriction same as that of the above-described first embodiment can be performed by storing such information in the storing unit 104.

The above-described first embodiment uses the loudspeaker 108 or the display unit 105 of the mobile terminal 100, or a vibrator not illustrated to alert the user, but does not intend to suggest any limitation. For example, the control unit 111 may transmit the resistance value of the intake prohibited or restricted food item stored in the storing unit 104 to the utensil 10 through intra-body communication or proximity communication in advance, and the control unit 14 of the utensil 10 may notify the user by vibrating the utensil 10 when the resistance value detected by the measuring electrode 11 is equal to the resistance value of the intake prohibited or restricted food item.

The above-described first embodiment alerts the user of the intake prohibited or restricted food item in accordance with the medicine being taken, but does not intend to suggest any limitation. For example, when heavy exercise is prohibited during the prescription period of the medicine, the control unit 111 may detect whether the user is doing heavy exercise based on the detection results of an acceleration sensor or a gyro sensor located in the mobile terminal 100 to notify the user of advice about avoiding the heavy exercise.

In the above-described first embodiment, the measuring electrode 11 of the utensil 10 detects the resistance value when the user puts a food item into the mouth, but this does not intend to suggest any limitation. The measuring electrode 11 may detect an amount of salt, an amount of sugar, or a calorie of the food item that has made in contact with the utensil 10. In this case, the control unit 111 may alert the user when the amount of salt, the amount of sugar, or the calorie exceeds the prescribed value in accordance with the disease that the user is suffering from, or may notify the user of the amount of salt consumed, the amount of sugar consumed, or the calorie.

In the above-described first embodiment, the control unit 111 transmits the information on the diet of the user to the mobile terminal 200 of the family member, but this does not intend to suggest any limitation. For example, the control unit 111 may transmit the information on the diet of the user to a terminal used by user's family doctor.

The user who is taking a medicine prescribed in a pharmacy may purchase over-the-counter medicines. Even in such a case, when the storing unit 104 stores information on over-the-counter medicines that are not to be taken together with the medicine prescribed in the pharmacy, and a device capable of transmitting the information on the over-the-counter medicine through intra-body communication (corresponding to the utensil 10 of the first embodiment) is attached to the over-the-counter medicine, the control unit 111 may alert the user when the user picks up the over-the-counter medicine that the user should not purchase in a drug store. This enables to prevent the user from erroneously purchasing the over-the-counter medicine that the user is prohibited from taking.

One or more of the processes executed by the control units 111, 211 may be executed by a server.

The above-described first embodiment employs the mobile terminal 100 as an electronic device, but does not intend to suggest any limitation. For example, the electronic device may be an instrument such as glasses, an acoustic aid, or a watch that is attached to a human body and has the functions of the mobile terminal 100 described in the above-described embodiment.

### Second Embodiment

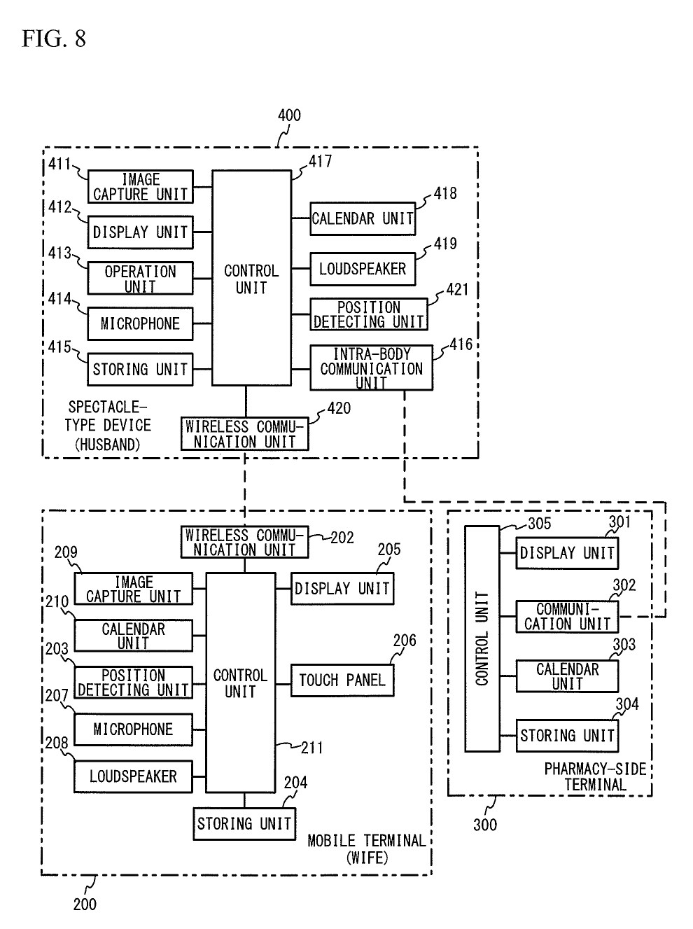

A detailed description will next be given of a second embodiment based on FIG. 8 through FIG. 10. The second embodiment employs, as illustrated in FIG. 8, a spectacle-type device 400 instead of the mobile terminal 100 used by the husband in the first embodiment, and general chopsticks, spoons, and forks instead of the utensils 10.

(Spectacle-Type Device 400)

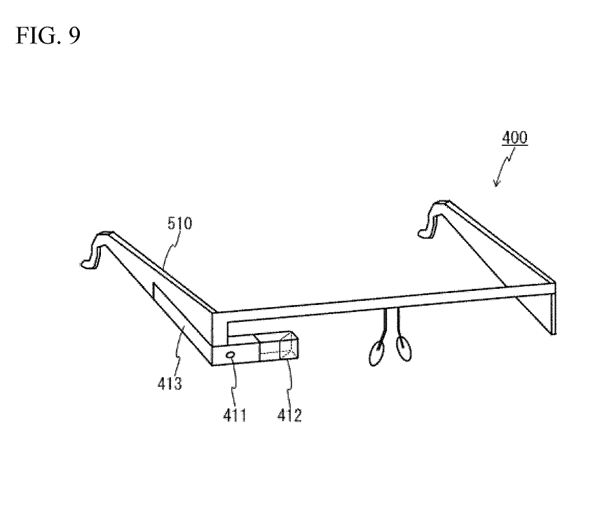

The spectacle-type device 400 includes, as illustrated in FIG. 8, an image capture unit 411, a display unit 412, an operation unit 413, a microphone 414, a storing unit 415, an intra-body communication unit 416, a calendar unit 418, a loudspeaker 419, a wireless communication unit 420, a position detecting unit 421, and a control unit 417. FIG. 9 is a perspective view of the spectacle-type device 400. As illustrated in FIG. 9, the spectacle-type device 400 includes a spectacle-type frame 510. The components of the spectacle-type device 400 illustrated in FIG. 8 but not illustrated in FIG. 9 are located inside the frame 510 or in a part of the frame 510.

The image capture unit 411 includes a lens, an imaging element, and an image processing unit, and captures still images and moving images. The image capture unit 411 is located near the end of the frame 510 (near the right eye of the user) as illustrated in FIG. 9. Thus, when the user (the husband) is wearing the spectacle-type device 400, images in a direction toward which the user faces (looks) can be captured.

The display unit 412 includes a projector located inside the frame 510 or near the frame 510, and a prism that guides the projection image from the projector to the eye of the user. The display unit 412 displays various information under the instruction from the control unit 417. In the second embodiment, the display unit 412 displays the letters, the image, or the illustration of the intake prohibited food item or the intake restricted food item illustrated FIG. 3 previously described. In this case, the data of the image and the illustration may be obtained from the Internet through the wireless communication unit 420 described later.

The operation unit 413 is a touch pad located in the frame 510, detects the motion of user's finger to receive the operation from the user, and transmits the operation information to the control unit 417.

The details of the image capture unit 411, the display unit 412, and the operation unit 413 are also disclosed in the U.S. Patent Application Publication No. 2013/0044042.

The microphone 414 is located in the frame 510, and collects the voice from the user and the sound around the user. The sound collected by the microphone 414 is sound-recognized by a sound recognition unit not illustrated, and the results of the sound recognition are transmitted to the control unit 417. The control unit 417 executes a process based on the results of the sound recognition (e.g., the command execution process). The control unit 417 may execute sound recognition.

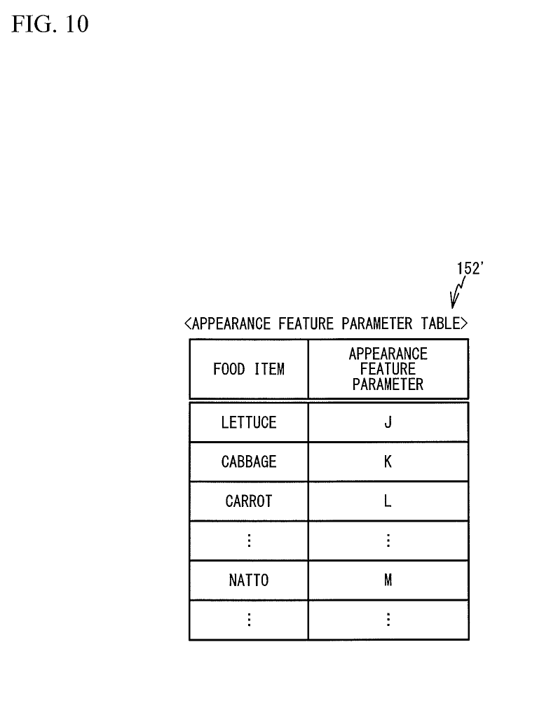

The storing unit 415 is a non-volatile semiconductor memory such as a flash memory, and stores image data of images captured by the image capture unit 411, display data to be displayed on the display unit 412, and various programs. The storing unit 415 also stores the intake combination table 150 of FIG. 3, the prescribed medicine table 154 of FIG. 5A, and the diet log 156 of FIG. 5B. The storing unit 415 further stores an appearance feature parameter table 152′ of FIG. 10.

The intra-body communication unit 416 communicates with other devices (the pharmacy-side terminal 300 in the second embodiment) through intra-body communication. Assume that the electrode unit of the intra-body communication unit 416 is located in the frame 510. As with in the first embodiment, proximity communication may be employed instead of intra-body communication.

The calendar unit 418 acquires time information such as year, month, date, and time as with in the first embodiment, and outputs it to the control unit 417. The calendar unit 418 may have a clocking function to measure the time taken for the user to finish a meal.

The loudspeaker 419 is a sound output device located, for example, in the frame 510, and outputs sound under the control of the control unit 417. The loudspeaker 419 may be earphones or headphones, or a loudspeaker having directional capabilities and being capable of providing sound information to mainly the user who is wearing the spectacle-type device 400.

The wireless communication unit 420 enables the communication with other devices (the mobile terminal 200 in the second embodiment) and the connection to a network, and may employ various wireless communication methods. In the second embodiment, the wireless communication unit 420 transmits information on the food item consumed by the user to the mobile terminal 200, and acquires the information on the intake combination of medicines and food items (the information of the intake combination table 150 (FIG. 3)) and the previously-described image or illustration from the Internet.

The position detecting unit 421 is, for example, a GPS module as with in the first embodiment.

The control unit 417 overall controls the spectacle-type device 400. The control unit 417 includes a CPU, a RAM, and a ROM.

In the second embodiment, each component of the spectacle-type device 400 has a function same as or similar to that of the corresponding component of the mobile terminal 100 described in the first embodiment.

(Mobile Terminal 200)

The fundamental configuration of the mobile terminal 200 is the same as that of the first embodiment. A wireless communication unit 202 communicates with the spectacle-type device 400 to receive the dietary history of the husband and the information on food items of which the intake by the husband is prohibited or restricted from the spectacle-type device 400. The mobile terminal 200 of the wife may be the spectacle-type device 400. The letters, the image, or the illustration of the intake prohibited or restricted food item may be displayed on the display unit 412 when the wife is in a supermarket based on the detection of a position detecting unit 203.

(Pharmacy-Side Terminal 300)

The fundamental configuration of the pharmacy-side terminal 300 is the same as that of the first embodiment. The communication unit 302 communicates with the intra-body communication unit 416 of the spectacle-type device 400 while the user (the husband) is wearing the spectacle-type device 400.

(Process by the Control Unit 417)

A description will next be given of a process executed by the control unit 417 of the spectacle-type device 400 of the second embodiment. The control unit 417 basically executes the process along the flowchart of FIG. 6 described in the first embodiment. Hereinafter, the processes different from those of the first embodiment are mainly described. The image capture unit 411 repeats image capturing at a predetermined time interval when capturing still images, whereas the image capture unit 411 captures images at a given frame rate when capturing a moving image.

In the process of FIG. 6, at step S10, the control unit 417 waits till it detects that the user has started a meal. In this case, the control unit 417 can determine that the meal has been started when detecting that the user takes chopsticks, a spoon, or a fork based on an image (a moving image or a still image) captured by the image capture unit 411. The control unit 417 may determine whether the user has started a meal by taking the detection results of the position detecting unit 421 or the date and time information output from the calendar unit 418 into consideration. The control unit 417 may determine that a meal has been started when the input of a specific word expressing gratitude before meals such as “itadakimasu” to the microphone 414 is detected by a voice-recognition technology. Here, the control unit 417 may display the letters, the image, or the illustration of the intake prohibited or restricted food item on the display unit 412 at the timing when the meal has been started or the timing of step S22. In addition, the control unit 417 may compare, when the storing unit 415 stores image data of the intake prohibited or restricted food item, the image captured by the image capture unit 411 to the image data of the food item, and notifies the user when the image of the intake prohibited or restricted food item is captured. The control unit 417 proceeds to step S12 after determining that the meal has been started.

At steps S12 through S16, the same processes as those of the first embodiment are executed.

At step S18, the control unit 417 logs the diet of the user. The control unit 417 detects that the user is going to convey or conveyed a food item into the mouth with chopsticks, a spoon, or a fork, or with user's hand based on the image captured by the image capture unit 411 and the appearance feature parameter table 152′ of FIG. 10. Here, the appearance feature parameter table 152′ stores food items in association with the appearance feature parameter. The appearance feature parameter is a scale that measures the feature quantity of the appearance of a food item such as the shape, the color of the surface, the pattern, the asperity of the food item with respect to each food item. When the control unit 417 detects that the user picks up a food item by chopsticks in the image captured by the image capture unit 411, and then detects that the food item approaches the image capture unit 411 and disappears from the chopsticks, it determines that the food item is a food item conveyed into the mouth (the food item that the user ate). Then, the control unit 417 calculates the feature quantity of the appearance from the shape, color, pattern, and asperity of the food item. Furthermore, the control unit 417 refers to the appearance feature parameter table 152′, and stores the food item corresponding to (or close to) the calculated feature quantity in the storing unit 415 (the diet log 156) as the food item that the user put into the mouth. The appearance feature parameter is also disclosed in Japanese Patent Application Publication No. 2013-214336. The control unit 417 may detect a food item to which the user puts chopsticks closer within a predetermined distance, or a food item picked up by the user with chopsticks as a food item that the user is going to put into the mouth.

The processes at steps S20 to S30 are the same as those of the first embodiment. In the alert at step S22, the control unit 417 may perform display relating to the alert on the display unit 412 of the spectacle-type device 400, or may output a sound to alert the user from the loudspeaker 419. At step S24, the control unit 417 may determine whether the meal is over based on the image captured by the image capture unit 411. In this case, the control unit 417 may determine that the meal is over when it detects, from the image, that the food on the table has been cleared or a dessert has been finished.

As described above, the second embodiment stores data on the intake prohibited or restricted food item in the storing unit 415, and the control unit 417 notifies the user through the display unit 412 or the loudspeaker 419 when it acquires information indicating that the user consumed or is going to consume a food item stored in the storing unit 415 from the image of the image capture unit 411. This configuration allows the user to avoid consuming a food item without checking the intake prohibited or restricted food item in advance before meals. Thus, the spectacle-type device 400 of the second embodiment allows the user to manage the intake of food items. The second embodiment has other effects same as those of the first embodiment.

The above-described second embodiment may use the utensil 10 of the first embodiment in combination. This configuration enables to detect the information indicating that the user consumed or is going to consume a food item with high accuracy. For example, the control unit 417 may identify a food item from the image captured by the image capture unit 411 when the food item cannot be identified from the resistance value measured by the measuring electrode 11 of the utensil 10 or there are several candidates for the food item. When it is impossible to identify whether the meat in the image captured by the image capture unit 411 is pork or beef, the meat may be identified from pork or beef based on the resistance value measured by the measuring electrode 11 of the utensil 10.

In the above-described second embodiment, the spectacle-type device 400 has the same functions as those of the mobile terminal 100 of the first embodiment, but this does not intend to suggest any limitation. For example, the spectacle-type device 400 has minimal functions such as the image capture unit 411, the storing unit 415, and the wireless communication unit 420, and other functions of the spectacle-type device 400 in FIG. 8 may be achieved by the mobile terminal 100 held by the user (husband).

One or more of the processes executed by the control unit 417 may be executed by a server.

The above-described second embodiment employs a spectacle-type device, but does not intend to suggest any limitation. The device may be a device attached to other positions (a position from which the image capture unit 411 can capture an image of user's glance) of the user body such as a contact lens type terminal.

In the above-described embodiments, the above-described processing functions are implemented by a computer. In this case, a program in which processing details of the functions that a processing device (CPU) is to have are written are provided. The execution of the program by the computer allows the computer to implement the above described processing functions. The program in which the processing details are written can be stored in a storage medium (however, excluding carrier waves) capable of being read by a computer.

When the program is distributed, it may be sold in the form of a portable storage medium such as a DVD (Digital Versatile Disc) or a CD-ROM (Compact Disc Read Only Memory) storing the program. The program may be stored in a storage device of a server computer, and the program may be transferred from the server computer to another computer over a network.

A computer executing the program stores the program stored in a portable storage medium or transferred from a server computer in its own storage device. The computer then reads the program from its own storage device, and executes a process according to the program. The computer may directly read the program from a portable storage medium, and execute a process according to the program.

Alternatively, the computer may successively execute a process, every time when the program is transferred from a server computer, according to the received program.

While the exemplary embodiments of the present invention have been illustrated in detail, the present invention is not limited to the above-mentioned embodiments, and other embodiments, variations and modifications may be made without departing from the scope of the present invention. The entire disclosure of the publication, the international publication, and the U.S. patent application publication cited in the above description is incorporated herein by reference.

### DESCRIPTION OF REFERENCE NUMERALS

100 mobile terminal
101 intra-body communication unit
102 wireless communication unit
104 storing unit
105 display unit
108 loudspeaker
111 control unit
200 mobile terminal
400 spectacle-type device

1-15. (canceled)

16. A method implemented by a computer, the method comprising:
obtaining information on a first medicine before being taken or information on a food or beverage before being consumed;
communicating with an external device that stores information on a second medicine being taken;
transmitting the information on the first medicine or the information on the food or beverage to the external device; and
notifying a user that the first medicine or the food or beverage is a medicine or a food or beverage that is prohibited or restricted from being consumed together with the second medicine when receiving information that the first medicine or the food or beverage is a medicine or a food or beverage that is prohibited or restricted from being consumed together with the second medicine.

17. A method implemented by a computer, the method comprising:
obtaining information on a first medicine before being taken or information on a food or beverage before being consumed;
communicating with an external device that stores information on a second medicine being taken;
transmitting the information on the first medicine or the information on the food or beverage to the external device; and
notifying a user that the second medicine is a medicine that is prohibited or restricted from being taken together with the first medicine or the food or beverage when receiving information that the second medicine is a medicine that is prohibited or restricted from being taken together with the first medicine or the food or beverage.

18. The method according to claim 16, wherein
the obtaining includes obtaining the information on the first medicine or the information on the food or beverage through an image capture unit that outputs image data.

19. The method according to claim 17, wherein
the obtaining includes obtaining the information on the first medicine or the information on the food or beverage through an image capture unit that outputs image data.

20. The method according to claim 18, wherein
the obtaining includes obtaining image data of the first medicine or image data of the food or beverage output from the image capture unit, and
the transmitting includes transmitting the image data to the external device.

21. The method according to claim 19, wherein
the obtaining includes obtaining image data of the first medicine or image data of the food or beverage output from the image capture unit, and
the transmitting includes transmitting the image data to the external device.

22. The method according to claim 16, wherein
the obtaining includes obtaining the information on the first medicine or the information on the food or beverage through an operation unit, and
the transmitting includes transmitting the information on the first medicine or the information on the food or beverage obtained through the operation unit to the external device.

23. The method according to claim 17, wherein
the obtaining includes obtaining the information on the first medicine or the information on the food or beverage through an operation unit, and
the transmitting includes transmitting the information on the first medicine or the information on the food or beverage obtained through the operation unit to the external device.

24. The method according to claim 16, further comprising:
receiving an amount of the first medicine or the food or beverage allowed to be consumed together with the second medicine,
wherein the notifying includes notifying the user of the amount of the first medicine or the food or beverage received.

25. The method according to claim 17, further comprising:
receiving an amount of the first medicine or the food or beverage allowed to be consumed together with the second medicine,
wherein the notifying includes notifying the user of the amount of the first medicine or the food or beverage received.

26. The method according to claim 16, wherein the obtaining includes obtaining the information on the second medicine through proximity communication.

27. The method according to claim 17, wherein the obtaining includes obtaining the information on the second medicine through proximity communication.

28. The method according to claim 16, wherein
the information on the first medicine or the information on the food or beverage includes at least one of a name of the first medicine or the food or beverage, a name of a medicine that is prohibited or restricted, and a name of disease for which a medicine is prescribed.

29. The method according to claim 17, wherein
the information on the first medicine or the information on the food or beverage includes at least one of a name of the first medicine or the food or beverage, a name of a medicine that is prohibited or restricted, and a name of disease for which a medicine is prescribed.

30. The method according to claim 16, wherein
the information on the second medicine includes at least one of a name of the second medicine, a name of a medicine that is prohibited or restricted, a name of disease for which a medicine is prescribed, a prescription date, and a prescription period.

31. The method according to claim 17, wherein
the information on the second medicine includes at least one of a name of the second medicine, a name of a medicine that is prohibited or restricted, a name of disease for which a medicine is prescribed, a prescription date, and a prescription period.

32. A device comprising:
a receive unit that receives information on a first medicine before being taken or information on a food or beverage before being consumed from an external device; and
a transmit unit that transmits information that the first medicine or the food or beverage is a medicine or a food or beverage that is prohibited or restricted from being consumed together with a second medicine being taken when it is determined that the first medicine or the food or beverage is a medicine or a food or beverage that is prohibited or restricted from being consumed together with the second medicine from the information on the first medicine or the information on the food or beverage and information on the second medicine.

33. A device comprising:
a receive unit that receives information on a first medicine before being taken or information on a food or beverage before being consumed from an external device; and
a transmit unit that transmits information that a second medicine being taken is a medicine that is prohibited or restricted from being taken together with the first medicine or the food or beverage when it is determined that the second medicine is a medicine that is prohibited or restricted from being taken together with the first medicine or the food or beverage from the information on the first medicine or the information on the food or beverage and information on the second medicine.

34. The device according to claim 32, wherein
the receive unit receives the information on the second medicine from an external storage device.

35. The device according to claim 33, wherein
the receive unit receives the information on the second medicine from an external storage device.

36. The device according to claim 32, further comprising:
a storing unit that stores information on the second medicine.

37. The device according to claim 33, further comprising:
a storing unit that stores information on the second medicine.

38. The device according to claim 32, wherein
the transmit unit transmits an amount of the first medicine or the food or beverage allowed to be consumed together with the second medicine.

39. The device according to claim 33, wherein
the transmit unit transmits an amount of the first medicine or the food or beverage allowed to be consumed together with the second medicine.

40. The device according to claim 32, wherein
the information on the first medicine or the information on the food or beverage includes at least one of a name of the first medicine or the food or beverage, a name of a medicine that is prohibited or restricted, and a name of disease for which a medicine is prescribed.

41. The device according to claim 33, wherein
the information on the first medicine or the information on the food or beverage includes at least one of a name of the first medicine or the food or beverage, a name of a medicine that is prohibited or restricted, and a name of disease for which a medicine is prescribed.

42. The device according to claim 32, wherein
the information on the second medicine includes at least one of a name of the second medicine, a name of a medicine that is prohibited or restricted, a name of disease for which a medicine is prescribed, a prescription date, and a prescription period.

43. The device according to claim 33, wherein
the information on the second medicine includes at least one of a name of the second medicine, a name of a medicine that is prohibited or restricted, a name of disease for which a medicine is prescribed, a prescription date, and a prescription period.
